(19) United States
(12) Patent Application Publication
(10) Pub. No.: US 2025/0269527 A1
(43) Pub. Date: Aug. 28, 2025

(54) METHOD AND APPARATUS FOR CONTROLLING MOBILE ROBOT, MOBILE ROBOT, AND STORAGE MEDIUM

(71) Applicant: Tencent Technology (Shenzhen) Company Limited, Shenzhen (CN)

(72) Inventors: Jingchen LI, Shezhen (CN); Shuai WANG, Shenzhen (CN); Xiong LI, Shenzhen (CN); Qinqin ZHOU, Shenzhen (CN); Haitao WANG, Shenzhen (CN); Dongsheng ZHANG, Shenzhen (CN); Lingzhu XIANG, Shenzhen (CN); Zhengyou ZHANG, Shenzhen (CN)

(73) Assignee: Tencent Technology (Shenzhen) Company Limited, Shenzhen (CN)

(21) Appl. No.: 19/197,286

(22) Filed: May 2, 2025

Related U.S. Application Data
(63) Continuation of application No. PCT/CN2023/131479, filed on Nov. 14, 2023.

(30) Foreign Application Priority Data
Apr. 25, 2023 (CN) 2023 10472257.6

(51) Int. Cl. B25J 9/16; B25J 5/00; B62D 57/032

(52) U.S. Cl. CPC B25J 9/1664; B25J 5/007; B62D 57/032

(57) ABSTRACT

A method, apparatus, and computer-readable storage medium for controlling a mobile robot, performed by a controller of the mobile robot, and the method comprising: controlling a first swing leg group to be located on a first stair or a first support surface, and controlling a second swing leg group to be located on a second stair; controlling the first swing leg group to swing to a third stair with the second swing leg group as a support leg; and controlling the second swing leg group to swing to a fourth stair with the first swing leg group as a support leg; wherein the first swing leg group and the second swing leg group comprise rotation shafts and a plurality of swing legs; wherein the first swing leg group and the second swing leg group are distributed side by side; and wherein the rotation shaft of the first swing leg group and the rotation shaft of the second swing leg group are located in the same vertical plane.

### CROSS-REFERENCE TO RELATED APPLICATIONS

This application is a continuation application of International Application No. PCT/CN2023/131479 filed on Nov. 14, 2023 which claims priority to Chinese Patent Application No. 202310472257.6, filed with the China National Intellectual Property Administration on Apr. 25, 2023, the disclosures of each being incorporated by reference herein in their entireties.

### FIELD

The disclosure relates to the field of computer technologies, and to a method and an apparatus for controlling a mobile robot, a mobile robot, and a storage medium.

### BACKGROUND

In the related art, robots utilize several methods for ascending staircases based on their structural designs. In smart robotics applications, humanoid biped robots employ alternating foot support to navigate stairs. Additionally, quadruped robots ascend staircases through the coordinated movement of four independent legs. Other robot types, such as those equipped with crawler and ratchet mechanisms, achieve stair climbing through rolling movements of these components. Furthermore, robots incorporating planet gear systems accomplish stair ascension through the synchronized revolution of multiple planetary gears.

However, these staircase ascending methods are limited to robots with specific structural configurations. When the robot's structural design deviates from these established forms, the aforementioned climbing techniques become ineffective. Therefore, how to develop a staircase ascending method applicable to robots with varied structural designs is an issue that requires urgent attention.

### SUMMARY

Provided are a method, an apparatus, and a storage medium for controlling a mobile robot to ascend staircases through the coordinated operation of two side-by-side swing leg groups. These embodiments enable a mobile robot to climb stairs by alternating support between the first and second swing leg groups, where each group comprises rotation shafts located in the same vertical plane and multiple swing legs. These embodiments also enhances the robot's ability to navigate staircases efficiently while maintaining stability, addressing the limitations of conventional stair-climbing mechanisms that depend on specific robot structural designs.

Some embodiments provide a method for controlling a mobile robot, performed by a controller of the mobile robot, and the method comprising: controlling a first swing leg group to be located on a first stair or a first support surface, and controlling a second swing leg group to be located on a second stair; controlling the first swing leg group to swing to a third stair with the second swing leg group as a support leg; controlling the second swing leg group to swing to a fourth stair with the first swing leg group as a support leg; wherein the first swing leg group and the second swing leg group comprise rotation shafts and a plurality of swing legs; wherein the first swing leg group and the second swing leg group are distributed side by side; and wherein the rotation shaft of the first swing leg group and the rotation shaft of the second swing leg group are located in the same vertical plane.

Some embodiments provide an apparatus for controlling a mobile robot, comprising: at least one memory configured to store program code; and at least one processor configured to read the program code and operate as instructed by the program code, the program code comprising: control code configured to cause at least one of the at least one processor to control the first swing leg group to be located on a first stair or a first support surface, and control the second swing leg group to be located on a second stair; wherein the control code is further configured to cause at least one of the at least one processor to control the first swing leg group to swing to a third stair with the second swing leg group as a support leg, wherein the control code is further configured to cause at least one of the at least one processor to control the second swing leg group to swing to a fourth stair with the first swing leg group as a support leg, wherein the first swing leg group and the second swing leg group comprise rotation shafts and a plurality of swing legs; wherein the first swing leg group and the second swing leg group are distributed side by side; and wherein the rotation shaft of the first swing leg group and the rotation shaft of the second swing leg group are located in the same vertical plane.

Some embodiments provide a non-transitory computer-readable storage medium, storing computer code which, when executed by at least one processor, causes the at least one processor to at least: control a first swing leg group to be located on a first stair or a first support surface, and control a second swing leg group to be located on a second stair; control the first swing leg group to swing to a third stair with the second swing leg group as a support leg; control the second swing leg group to swing to a fourth stair with the first swing leg group as a support leg; wherein the first swing leg group and the second swing leg group comprise rotation shafts and a plurality of swing legs; wherein the first swing leg group and the second swing leg group are distributed side by side; and wherein the rotation shaft of the first swing leg group and the rotation shaft of the second swing leg group are located in the same vertical plane.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a side view of a mobile robot according to some embodiments.

FIG. 2 is a side view of a mobile robot according to some embodiments.

FIG. 3 is a flowchart of a method for controlling a mobile robot according to some embodiments.

FIG. 4 is a schematic diagram of a quasi-static staircase ascending action sequence according to some embodiments.

FIG. 5 is a schematic diagram of a static staircase ascending action sequence according to some embodiments.

FIG. 6 is a flowchart of a method for controlling a mobile robot according to some embodiments.

FIG. 7 is a schematic diagram of a method for controlling a mobile robot when both two swing leg groups are in contact with a stair according to some embodiments.

FIG. 8 is a schematic diagram of a method for controlling a mobile robot when both two swing leg groups are in contact with a stair according to some embodiments.

FIG. 9 is a schematic diagram of a method for controlling a mobile robot when only one swing leg group is in contact with a stair according to some embodiments.

FIG. 10 is a flowchart of a method for controlling a mobile robot according to some embodiments.

FIG. 11 is a schematic diagram of a force analysis of a mobile robot according to some embodiments.

FIG. 12 is a schematic diagram of an apparatus for controlling a mobile robot according to some embodiments.

FIG. 13 is a block diagram of a mobile robot according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

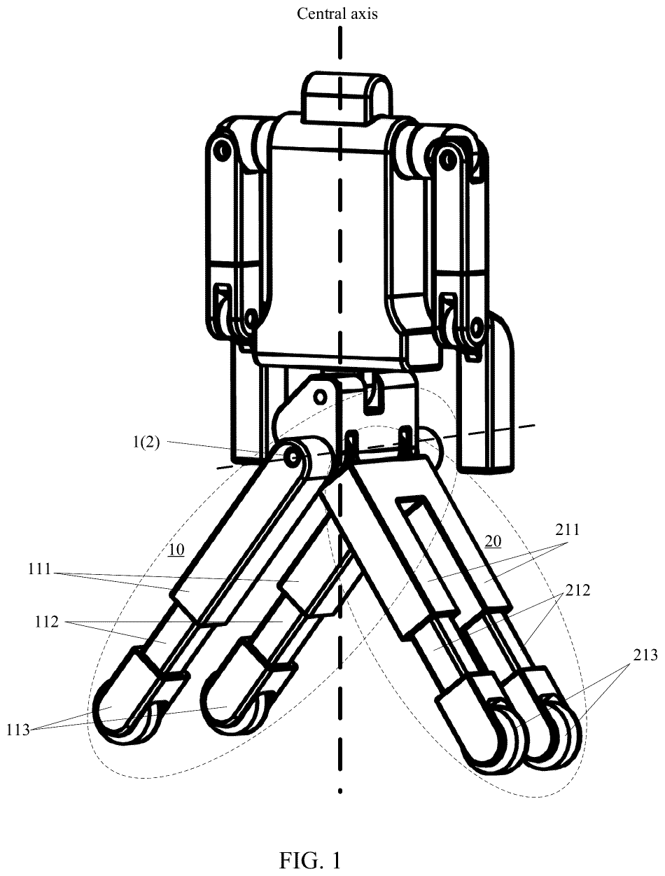

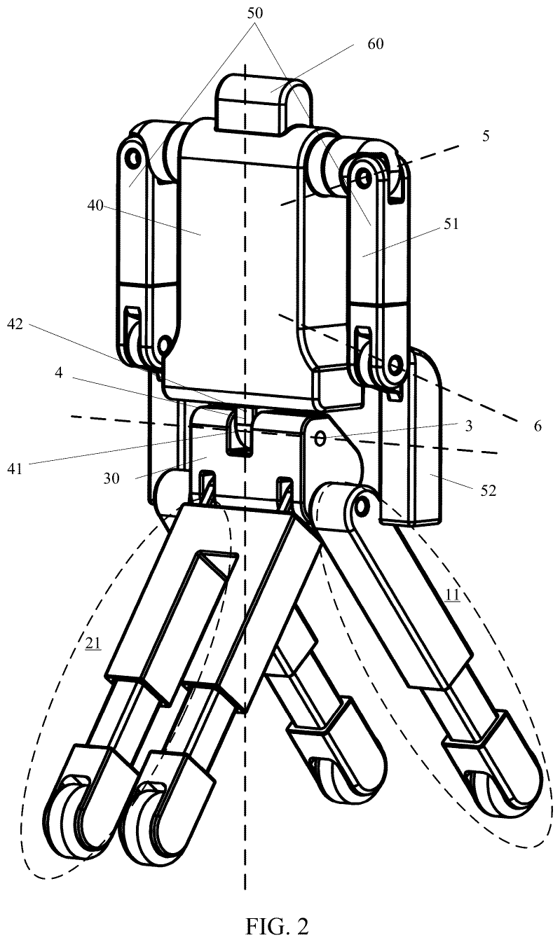

With reference to FIG. 1 and FIG. 2, it may be observed that a mobile robot according to some embodiments includes at least three swing legs. The at least three swing legs are distributed side by side, and rotation shafts of the at least three swing legs are located in the same vertical plane. Distributed side by side refers to a state in which projections of the at least three swing legs of the mobile robot in a first direction do not overlap. That the rotation shafts are located in the same vertical plane refers to a state in which projections of the at least three swing legs of the mobile robot in a second direction do not overlap. The first direction refers to a front or back orientation of the mobile robot. The second direction refers to a side orientation of the mobile robot. Optionally, rotation shafts of at least two of the at least three swing legs are coaxial. Optionally, rotation shafts of the at least three swing legs are non-axial.

In some embodiments, the at least three swing legs are divided into a first swing leg group and a second swing leg group. Optionally, the first swing leg group includes a plurality of first swing legs, the second swing leg group includes one second swing leg, at least two of the plurality of first swing legs are located on two sides of a central axis of the mobile robot, and the second swing leg is located on the central axis of the mobile robot. Optionally, the second swing leg group includes a plurality of second swing legs, the first swing leg group includes one first swing leg, at least two of the plurality of second swing legs are located on two sides of a central axis of the mobile robot, and the first swing leg is located on the central axis of the mobile robot.

In some embodiments, the at least three swing legs are divided into a first swing leg group and a second swing leg group. Optionally, the first swing leg group includes a plurality of first swing legs, the second swing leg group includes a plurality of second swing legs, and the plurality refers to a case of greater than or equal to two.

With reference to FIG. 1 and FIG. 2, FIG. 1 and FIG. 2 show side views of a mobile robot according to some embodiments. The mobile robot includes a first swing leg group 10 and a second swing leg group 20. The first swing leg group 10 includes a plurality of first swing legs 11, the second swing leg group 20 includes a plurality of second swing legs 21, at least two of the plurality of first swing legs 11 are respectively located at two sides of a central axis of the mobile robot, and at least two of the plurality of second swing legs 21 are respectively located at two sides of the central axis of the mobile robot. The plurality of first swing legs 11 and the plurality of second swing legs 21 are distributed side by side. If the foregoing distribution condition is satisfied, further optionally, the plurality of first swing legs 11 and the plurality of second swing legs 21 are distributed in a staggered manner one by one. Optionally, the plurality of first swing legs 11 are distributed on two sides of the plurality of second swing legs 21.

Schematically, using an example in which the first swing leg group 10 is a group A of legs, and the second swing leg group 20 is a group B of legs, a case in which the plurality of first swing legs 11 and the plurality of second swing legs 21 are distributed side by side may be A1, B1, B2, and A2 (a distribution case 1); A1, B1, A2, and B2 (a distribution case 2); A1, A2, B1, A3, B2, and B3 (a distribution case 3); A1, A2, B1, B2, B3, A3 (a distribution case 4), and the like. Similarly, more or less swing legs may be arranged in a similar manner of being arranged side by side.

With reference to FIG. 1 and FIG. 2, FIG. 1 and FIG. 2 show that the first swing leg group 10 includes two first swing legs (outer legs) 11, and the second swing leg group 20 includes two second swing legs (inner legs) 21. The two first swing legs 11 are symmetrically distributed along a central axis of the mobile robot, and the two second swing legs 21 are symmetrically distributed along the central axis of the mobile robot. A distance between the first swing legs 11 and the central axis is greater than a distance between the second swing legs 21 and the central axis.

In a traveling process of the mobile robot, the first swing leg group 10 and the second swing leg group 20 support traveling in a cross gait, that is, the first swing leg group 10 and the second swing leg group 20 alternately travel as front and back leg groups, respectively. In an exemplary traveling process, the second swing leg group 20 is swung to a first landing point by using the first swing leg group 10 as a support leg, and subsequently, the first swing leg group 10 is swung to a second landing point by using the second swing leg group 20 as a support leg.

In an initial posture, the plurality of first swing legs 11 are in contact with the ground as front legs, and the plurality of second swing legs 21 are in contact with the ground as rear legs. In this case, a projection of a center of gravity of the robot is located within a geometric figure formed by contact points between the front and rear legs and the ground. The plurality of first swing legs 11 are used as support legs, the plurality of second swing legs 21 are swung to the first landing point, and meanwhile, the center of gravity of the robot is controlled to move forward. The center of gravity of the robot is controlled to be located within the geometric figure formed by the contact points between the front and back legs and the ground again when the plurality of second swing legs 21 swing to the first landing point. The plurality of second swing legs 21 are used as support legs, the plurality of first swing legs 11 are swung to the first landing point, and meanwhile, the center of gravity of the robot is controlled to move forward. The center of gravity of the robot is controlled to be located within the geometric figure formed by the contact points between the front and back legs and the ground again when the plurality of second swing legs 21 swing to the second landing point.

The swing legs are controlled to telescope when the swing legs of the robot swing. Schematically, the swing legs are controlled to retract if the centers of gravity of the swing legs are located behind the center of gravity of the mobile robot. The swing legs are controlled to extend if the centers of gravity of the swing legs are located in front of the center of gravity of the mobile robot.

According to the foregoing mobile robot, a first swing leg group and a second swing leg group are arranged, the first swing leg group includes a plurality of first swing legs, the second swing leg group includes a plurality of second swing legs, at least two of the plurality of first swing legs are respectively located at two sides of a central axis of the mobile robot, at least two of the plurality of second swing legs are respectively located at two sides of the central axis of the mobile robot, and the plurality of first swing legs and the plurality of second swing legs are distributed side by side, so that static stability of the mobile robot in a standing posture can be achieved, and a location of the center of gravity of the mobile robot does not need to be dynamically adjusted. In addition, the foregoing mobile robot supports traveling in a cross gait. In a traveling process, the mobile robot does not need to consider a problem about balance in a rolling direction, and the rolling direction is a direction perpendicular to the traveling direction.

In some embodiments, the plurality of first swing legs 11 are rotatably connected to a first swing rotation shaft, and the first swing rotation shaft is perpendicular to a traveling direction of the mobile robot. Optionally, the first swing rotation shaft is located at a position such as a hip, a waist, or a head top of the mobile robot. In some embodiments, the plurality of second swing legs 21 are rotatably connected to a second swing rotation shaft, and the second swing rotation shaft is perpendicular to a traveling direction of the mobile robot. Optionally, the second swing rotation shaft is located at a position such as a hip, a waist, or a head top of the mobile robot.

In some embodiments, the first swing rotation shaft is located at a hip of the mobile robot. With reference to FIG. 1, in this case, the first swing rotation shaft is a first hip rotation shaft 1, and the first hip rotation shaft 1 extends horizontally when the mobile robot stands on a horizontal base plane. The plurality of first swing legs 11 are rotatably connected to the first hip rotation shaft 1, and any two of the plurality of first swing legs 11 are parallel.

In some embodiments, the second swing rotation shaft is located at a hip of the mobile robot. With reference to FIG. 1, in this case, the second swing rotation shaft is a second hip rotation shaft 2, and the second hip rotation shaft 2 extends horizontally when the mobile robot stands on a horizontal base plane. The plurality of second swing legs 21 are rotatably connected to the second hip rotation shaft 2, and any two of the plurality of second swing legs 21 are parallel.

Optionally, the first hip rotation shaft 1 and the second hip rotation shaft 2 are coaxial; and/or, the first hip rotation shaft 1 and the second hip rotation shaft 2 are located on the same vertical plane. FIG. 1 and FIG. 2 show a case in which the first hip rotation shaft 1 and the second hip rotation shaft 2 are coaxial and are located on the same vertical plane.

In some embodiments, the mobile robot further includes a first rotation rotating motor and a second rotating motor. The first rotating motor is configured to drive the plurality of first swing legs 11 in the first swing leg group 10 to interactively rotate around the first hip rotation shaft 1. The second rotating motor is configured to drive the plurality of second swing legs 21 in the second swing leg group 20 to interactively rotate around the second hip rotation shaft 2.

In some embodiments, the mobile robot further includes a third rotating motor corresponding to the first swing leg 11 and a fourth rotating motor corresponding to the second swing leg 21. The third rotating motor is configured to drive the first swing leg 11 to rotate around the first hip rotation shaft 1. The fourth rotating motor is configured to drive the second swing leg 21 to rotate around the second hip rotation shaft 2. Optionally, the plurality of third rotating motors respectively corresponding to the plurality of first swing legs 11 support controlling the plurality of first swing legs 11 to interactively or independently rotate. Optionally, the plurality of fourth rotating motors respectively corresponding to the plurality of second swing legs 21 support controlling the plurality of second swing legs 21 to interactively or independently rotate.

With reference to FIG. 1 and FIG. 2, the first swing leg 11 includes a first mechanical thigh 111 and a first mechanical calf 112, and the first mechanical thigh 111 is connected to the first mechanical calf 112 in a sleeving manner. Optionally, the first mechanical thigh 111 is nested inside the first mechanical calf 112 in a sleeving state, and the first mechanical thigh 111 is telescoped in the sleeving direction during telescoping. Optionally, the first mechanical calf 112 is nested inside the first mechanical thigh 111 in a sleeving state, and a first mechanical calf 112 is telescoped in the sleeving direction during telescoping (a case shown in FIG. 1 and FIG. 2). Optionally, the first mechanical thigh 111 and the first mechanical calf 112 are nested inside middleware in a sleeving state, and the first mechanical thigh 111 and the first mechanical calf 112 are telescoped in a sleeving direction during telescoping.

The second swing leg 21 includes a second mechanical thigh 211 and a second mechanical calf 212. The second mechanical thigh 211 is connected to the second mechanical calf 212 in a sleeving manner. Optionally, the second mechanical thigh 211 is nested inside the second mechanical calf 212 in a sleeving state, and the second mechanical thigh 211 is telescoped in a sleeving direction during telescoping. Optionally, the second mechanical calf 212 is nested inside the second mechanical thigh 211 in a sleeving state, and the second mechanical calf 212 is telescoped in a sleeving direction during telescoping (a case shown in FIG. 1 and FIG. 2). Optionally, the second mechanical thigh 211 and the second mechanical calf 212 are nested inside middleware in a sleeving state, and the second mechanical thigh 211 and the second mechanical calf 212 are telescoped in a sleeving direction during telescoping.

In some embodiments, the mobile robot further includes a first telescopic motor corresponding to the first swing leg 11, and a second telescopic motor corresponding to the second swing leg 21. The first telescopic motor is configured to drive the first swing leg 11 to telescope in a sleeving direction. The second telescopic motor is configured to drive the second swing leg 21 to telescope in the sleeving direction. Optionally, the first telescopic motor is a first linear motor. Optionally, the first telescopic motor is a motor designed to implement linear transmission by using a lead screw nut. Optionally, the second telescopic motor is a second linear motor. Optionally, the second telescopic motor is a motor designed to implement linear transmission by using a lead screw nut.

In some embodiments, a plurality of first telescopic motors respectively corresponding to the plurality of first swing legs 11 support controlling the plurality of first swing legs 11 to interactively telescope or independently telescope. Optionally, a plurality of second telescopic motors respectively corresponding to the plurality of second swing legs 21 support controlling the plurality of second swing legs 21 to interactively telescope or independently telescope.

In some embodiments, the first swing leg 11 includes a first mechanical thigh 111 and a first mechanical calf 112, and the first mechanical thigh 111 is rotatably connected to the first mechanical calf 112 through a first knee joint rotation shaft. The first knee joint rotation shaft supports increasing or decreasing an included angle between the first mechanical thigh 111 and the first mechanical calf 112. The second swing leg 21 includes a second mechanical thigh 211 and a second mechanical calf 212, and the second mechanical thigh 211 is rotatably connected to the second mechanical calf 212 through a second knee joint rotation shaft. The second knee joint rotation shaft supports increasing or decreasing an included angle between the second mechanical thigh 211 and the second mechanical calf 212.

In some embodiments, the first swing leg group 10 includes a plurality of first swing legs 11, and the first swing leg 11 includes a first leg assembly and a first wheel 113 located at an end of the first leg assembly. The second swing leg group 20 includes a plurality of second swing legs 21, and the second swing leg 21 includes a second leg assembly and a second wheel 213 located at an end of the second leg assembly. Optionally, the first wheel 113 is a wheel having a multi-directional degree of freedom, and the first wheel 113 supports rotation in any direction. Optionally, the second wheel 213 is a wheel having a multi-directional degree of freedom, and the second wheel 213 supports rotation in any direction. With reference to FIG. 1 and FIG. 2, the first leg assembly includes a first mechanical thigh 111 and a first mechanical calf 112, and the second leg assembly includes a second mechanical thigh 211 and a second mechanical calf 212.

In some embodiments, the mobile robot further includes a first driving motor corresponding to the first wheel 113, and a second driving motor corresponding to the second wheel 213. The first driving motor is configured to drive the first wheel 113 to rotate. The second driving motor is configured to drive the second wheel 213 to rotate.

In some embodiments, a plurality of first driving motors respectively corresponding to the plurality of first swing legs 11 support controlling the plurality of first wheels 113 to perform interactively rotate or independently rotate. Optionally, a plurality of second driving motors respectively corresponding to the plurality of second swing legs 21 support controlling the plurality of second wheels 213 to perform interactively rotate or independently rotate.

In some embodiments, the mobile robot further includes a waist structure 30 and a torso structure 40. The waist structure 30 is configured to connect the leg structure and the torso structure 40. The leg structure includes a first swing leg group 10 and a second swing leg group 20.

In some embodiments, the waist structure 30 includes a pitch rotation shaft 3. The pitch rotation shaft 3 is parallel to a rotation shaft of the first swing leg group 10, and/or the pitch rotation shaft 3 is parallel to a rotation shaft of the second swing leg group 20. Schematically, with reference to FIG. 1 and FIG. 2, the pitch rotation shaft 3 is parallel to the first hip rotation shaft 1 (to the second hip rotation shaft 2). The pitch rotation shaft 3 is rotatably connected to the torso structure 40, and the pitch rotation shaft 3 is configured to support the torso structure 40 to perform a pitching operation.

In some embodiments, the waist structure 30 includes a side swing rotation shaft 4. The side swing rotation shaft 4 is perpendicular to a rotation shaft of the first swing leg group 10, and/or the side swing rotation shaft 4 is perpendicular to a rotation shaft of the second swing leg group 20. With reference to FIG. 1 and FIG. 2, the side swing rotation shaft 4 is perpendicular to the first hip rotation shaft 1 (to the second hip rotation shaft 2). The side swing rotation shaft 4 is rotatably connected to the torso structure 40, and the side swing rotation shaft 4 is configured to support the torso structure 40 to perform a side swing operation.

In some embodiments, the waist structure 30 includes a pitch rotation shaft 3 and a side swing rotation shaft 4. The pitch rotation shaft 3 is parallel to a rotation shaft of the first swing leg group 10, and/or the pitch rotation shaft 3 is parallel to a rotation shaft of the second swing leg group 20. With reference to FIG. 1 and FIG. 2, the pitch rotation shaft 3 is parallel to the first hip rotation shaft 1 (to the second hip rotation shaft 2). The pitching rotation shaft 3 is configured to support the torso structure 40 to perform a pitching operation. The side swing rotation shaft 4 is perpendicular to the pitch rotation shaft 3. A first end 41 of the side swing rotation shaft 4 is connected to a center of the pitch rotation shaft 3, a second end 42 of the side swing rotation shaft 4 is connected to the torso structure 40, and the side swing rotation shaft 4 is configured to support the torso structure 40 to perform a side swing operation.

In some embodiments, the mobile robot further has at least one operating arm 50. With reference to FIG. 1 and FIG. 2, FIG. 1 and FIG. 2 show that the mobile robot has two operating arms 50, and the two operating arms 50 are symmetrically distributed along a central axis of the robot.

Optionally, the operating arm 50 is connected to a shoulder rotation shaft 5 of the mobile robot. The shoulder rotation shaft 5 is configured to support the operating arm 50 to have a multi-directional rotation degree of freedom. Optionally, the shoulder rotation shaft 5 supports the operating arm 50 to rotate within a rotation angle range allowed by a structure of the robot. In some embodiments, the mobile robot further includes a shoulder driving motor corresponding to the shoulder rotation shaft 5. The shoulder driving motor is configured to drive the operating arm 50 to rotate. In some embodiments, a plurality of shoulder driving motors respectively corresponding to a plurality of shoulder rotation shafts 5 support controlling the plurality of operating arms 50 to interactively rotate or independently rotate.

Optionally, the operating arm 50 includes a mechanical upper arm 51 and a mechanical lower arm 52. The mechanical upper arm 51 is connected to the mechanical lower arm 52 through an elbow joint rotation shaft 6. The elbow joint rotation shaft 6 is configured to support the mechanical lower arm 52 to have a multi-directional rotation degree of freedom. Optionally, the elbow joint rotation shaft 6 supports the mechanical lower arm 52 to rotate within a rotation angle range allowed by a structure of the robot. In some embodiments, the mobile robot further includes an elbow joint driving motor corresponding to the elbow joint rotation shaft 6. The elbow joint driving motor is configured to drive the mechanical lower arm 52 to rotate. In some embodiments, a plurality of elbow joint driving motors respectively corresponding to the plurality of elbow joint rotation shafts 6 support controlling the plurality of mechanical lower arms 52 to interactively rotate or independently rotate.

In some embodiments, a claw is connected to an end of the mechanical lower arm 52. In some embodiments, the mobile robot further has a head 60, and the head 60 is located above the torso structure 40.

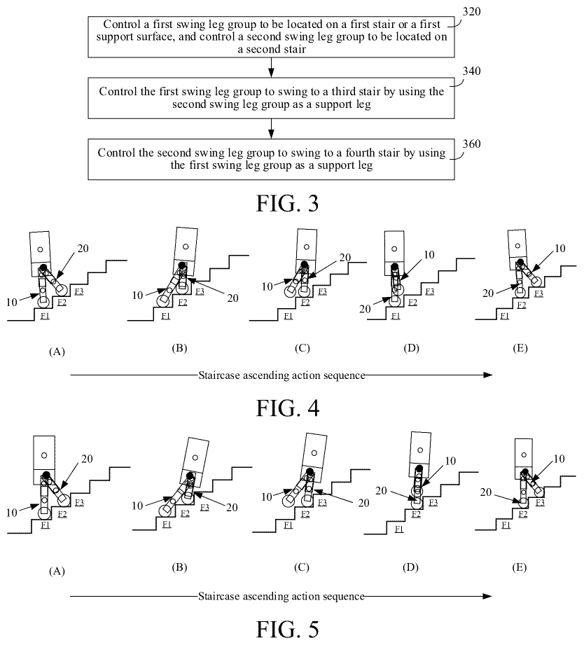

FIG. 3 shows a flowchart of a method for controlling a mobile robot according to some embodiments. An example in which the method is performed by a controller for a mobile robot shown in FIG. 1 or FIG. 2 is configured for description. The controller of the mobile robot is located in a body or outside the mobile robot. The method includes the following operations.

Operation 320: Control a first swing leg group to be located on a first stair or a first support surface, and control a second swing leg group to be located on a second stair.

FIG. 3 shows a flowchart of staircase ascending or descending method for a mobile robot. In some embodiments, the mobile robot includes a first swing leg group and a second swing leg group, the first swing leg group includes a plurality of first swing legs and/or the second swing leg group includes a plurality of second swing legs, the first swing leg group and the second swing leg group are distributed side by side, and a rotation shaft of the first swing leg group and a rotation shaft of the second swing leg group are located in the same vertical plane. At least one of the first swing leg group and the second swing leg group includes a plurality of swing legs. Optionally, the first swing leg group includes a plurality of first swing legs, and the second swing leg group includes one second swing leg. Or, the first swing leg group includes one first swing leg, and the second swing leg group includes a plurality of second swing legs. Or, the first swing leg group includes a plurality of first swing legs, and the second swing leg group includes a plurality of second swing legs.

In some embodiments, the first swing leg group includes a plurality of first swing legs, the second swing leg group includes a plurality of second swing legs, the plurality of first swing legs include at least two first swing legs respectively located at two sides of a central axis of the mobile robot, and the plurality of second swing legs includes at least two second swing legs respectively located at two sides of the central axis of the mobile robot, so that stability in a rolling direction is maintained when the two swing leg groups of the mobile robot ascend or descend a staircase alternately, a problem about balance in the rolling direction does not need to be considered, and the rolling direction is a direction perpendicular to a traveling direction.

In some embodiments, FIG. 3 shows a method for controlling a robot when ascending a staircase. The method in FIG. 3 shows a complete staircase ascending cycle of a mobile robot. In an initial state of the staircase ascending cycle, the first swing leg group is located on the first stair or the first support surface, the second swing leg group is located on the second stair, and the second stair is higher than the first stair and the first support surface. The first support surface indicates a base surface on which the robot is located before the robot starts to ascend a staircase.

In the staircase ascending cycle shown in FIG. 3, an initial stair (or an initial support surface) on which the first swing leg group is located is lower than an initial stair on which the second swing leg group is located. Similarly, a similar staircase ascending cycle in which the initial stair on which the second swing leg group is located is lower than the initial stair on which the first swing leg group is located may be obtained.

In some embodiments, FIG. 3 shows a method for controlling a robot when descending a staircase. The method in FIG. 3 shows a complete staircase descending cycle of a mobile robot. In an initial state of the staircase descending cycle, the first swing leg group is located on the first stair or the first support surface, the second swing leg group is located on the second stair, the second stair is lower than the first stair, and the second stair is lower than the first support surface. The first support surface is a base surface on which the robot is located before the robot starts to descend a staircase.

In the staircase descending cycle shown in FIG. 3, an initial stair (or an initial support surface) on which the first swing leg group is located is higher than an initial stair on which the second swing leg group is located. Similarly, a similar staircase descending cycle in which the initial stair on which the second swing leg group is located is higher than the initial stair on which the first swing leg group is located may be obtained.

Operation 340: Control the first swing leg group to swing to a third stair by using the second swing leg group as a support leg.

In some embodiments, FIG. 3 shows a method for controlling a robot when ascending a staircase. The second swing leg group is in contact with the second stair, and the second swing leg group is supported by the second stair. The mobile robot is controlled to swing the first swing leg group to swing the first swing leg group from the first stair to the third stair, and the third stair is a stair higher than the second stair.

In some embodiments, FIG. 3 shows a method for controlling a robot when descending a staircase. The second swing leg group is in contact with the second stair, and the second swing leg group is supported by the second stair. The mobile robot is controlled to swing the first swing leg group to swing the first swing leg group from the first stair to the third stair, and the third stair is a stair lower than the second stair.

In some embodiments, in a process of swinging the first swing leg group, the first swing leg group not only needs to be controlled to perform a swinging action, but also needs to be controlled to perform a telescoping action. That is, operation S340 includes: controlling the first swing leg group to telescope and swing to the third stair by using the second swing leg group as the support leg.

Schematically, the first swing leg group is controlled to shorten and swing by using the second swing leg group as a support leg until an extension direction of the first swing leg group is parallel to a gravity direction. Then, the first swing leg group is controlled to extend and swing until the first swing leg group is located on the third stair.

In some embodiments, the first swing leg of the first swing leg group includes a first mechanical thigh and a first mechanical calf. The first mechanical thigh is connected to the first mechanical calf in a sleeving manner. The sleeving manner supports telescoping the first mechanical thigh in a sleeving direction, or telescoping the first mechanical calf in a sleeving direction, or telescoping the first mechanical thigh and the first mechanical calf in a sleeving direction. In a process of swinging the first swing leg group, the first swing leg group is controlled to shorten and swing by using the second swing leg group as a support leg until an extension direction of the first swing leg group is parallel to a gravity direction. Then, the first swing leg group is controlled to extend and swing until the first swing leg group is located on the third stair.

FIG. 4 shows a staircase ascending action sequence. The staircase ascending manner shown in FIG. 4 is quasi-static staircase ascending. Part (A) in FIG. 4 shows that a first swing leg group 10 is located on a first stair F1, and a second swing leg group 20 is located on a second stair F2. With reference to part (A) in FIG. 4 and part (C) in FIG. 4, the first swing leg group 10 is shortened. Part (E) in FIG. 4 shows that the first swing leg group 10 is located on a third stair F3, and the second swing leg group 20 is located on the second stair F2. With reference to part (C) in FIG. 4 and part (E) in FIG. 4, the first swing leg group 10 is extended.

FIG. 5 shows another staircase ascending action sequence. The staircase ascending manner shown in FIG. 5 is static staircase ascending. Part (A) in FIG. 5 shows that a first swing leg group 10 is located on a first stair F1, and a second swing leg group 20 is located on a second stair F2. With reference to part (A) in FIG. 5 and part (D) in FIG. 5, the first swing leg group 10 is shortened. Part (E) in FIG. 5 shows that the first swing leg group 10 is located on a third stair F3, and the second swing leg group 20 is located on the second stair F2. With reference to part (D) in FIG. 5 and part (E) in FIG. 5, the first swing leg group 10 is extended.

In another embodiment, the first swing leg of the first swing leg group includes a first mechanical thigh and a first mechanical calf, the first mechanical thigh is connected to the first mechanical calf through a first knee joint rotation shaft. The first knee joint rotation shaft supports increasing or decreasing an included angle between the first mechanical thigh and the first mechanical calf. In a process of swinging the first swing leg group, the first swing leg group is controlled to bend and swing by using the second swing leg group as a support leg until an extension direction of the first swing leg group is parallel to a gravity direction. Then, the first swing leg group is controlled to straighten and swing until the first swing leg group is located on the third stair.

Operation 360: Control the second swing leg group to swing to a fourth stair by using the first swing leg group as a support leg.

In some embodiments, FIG. 3 shows a method for controlling a robot when ascending a staircase. The foregoing operation 340 describes a process of swinging the first swing leg group by using the second swing leg group as a support leg in a staircase ascending action process. Operation 360 is similarly implemented as a process of swinging the second swing leg group by using the first swing leg group as a support leg in the staircase ascending action process. In a swinging process in operation 360, the first swing leg group is in contact with the third stair, the first swing leg group is supported by the third stair, and the mobile robot is controlled to swing the second swing leg group to swing the second swing leg group from the second stair to the fourth stair, and the fourth stair is higher than the third stair.

In some embodiments, FIG. 3 shows a method for controlling a robot when descending a staircase. The foregoing operation 340 describes a process of swinging the first swing leg group by using the second swing leg group as a support leg in a staircase descending action process. Stair 360 is similarly implemented as a process of swinging the second swing leg group by using the first swing leg group as a support leg in a staircase descending action process. In a swinging process in operation 360, the first swing leg group is in contact with the third stair, the first swing leg group is supported by the third stair, and the mobile robot is controlled to swing the second swing leg group to swing the second swing leg group from the second stair to the fourth stair, and the fourth stair is lower than the third stair.

In some embodiments, in a process of swinging the second swing leg group, the second swing leg group not only needs to be controlled to perform a swinging action, but also needs to be controlled to perform a telescoping action. That is, operation S360 includes: controlling the second swing leg group to telescope and swing to the third stair by using the first swing leg group as the support leg.

Schematically, the second swing leg group is controlled to shorten and swing by using the first swing leg group as a support leg until an extension direction of the second swing leg group is parallel to a gravity direction. The second swing leg group is controlled extend and swing until the second swing leg group is located on the fourth stair.

In some embodiments, the second swing leg of the second swing leg group includes a second mechanical thigh and a second mechanical calf. The second mechanical thigh is connected to the second mechanical calf in a sleeving manner. The sleeving manner supports telescoping the second mechanical thigh in a sleeving direction, or telescoping the second mechanical calf in a sleeving direction, or telescoping the second mechanical thigh and the second mechanical calf in a sleeving direction. In a process of swinging the second swing leg group, the second swing leg group is controlled to shorten and swing by using the second swing leg group as a support leg until an extension direction of the second swing leg group is parallel to a gravity direction. Then, the second swing leg group is controlled to extend and swing until the second swing leg group is located on the fourth stair.

In another embodiment, the second swing leg of the second swing leg group includes a second mechanical thigh and a second mechanical calf, the second mechanical thigh is connected to the second mechanical calf through a second knee joint rotation shaft, and the second knee joint rotation shaft supports increasing or decreasing an included angle between the second mechanical thigh and the second mechanical calf. In a process of swinging the second swing leg group, the second swing leg group is controlled to bend and swing by using the first swing leg group as a support leg until an extension direction of the second swing leg group is parallel to a gravity direction. Then, the second swing leg group is controlled to straighten and swing until the second swing leg group is located on the fourth stair.

In conclusion, two swing leg groups (at least one of the two swing leg groups includes a plurality of swing legs) ascend/descend a staircase alternatively, and a solution for a mobile robot to ascend/descend a staircase is provided. In this solution, safety of the mobile robot is relatively high, difficulty in implementing ascending/descending a staircase is relatively low, the robot has a relatively large stability margin, and a real machine implementation risk can be reduced.

In addition, when the plurality of first swing legs of the first swing leg group include at least two first swing legs respectively located at two sides of a central axis of the mobile robot, and the plurality of second swing legs of the second swing leg group include at least two second swing legs respectively located at two sides of the central axis of the mobile robot, balance of the mobile robot in a rolling direction when ascending or descending a staircase is ensured, the balance of the rolling direction does not need to be controlled by an additional algorithm, and the rolling direction is a direction perpendicular to a traveling direction of the mobile robot.

In addition, in a process in which the two swing leg groups alternately ascend or descend a staircase, legs are further telescoped, thereby providing a staircase ascending and descending solution for a robot having a leg telescoping function.

Based on some embodiments shown in FIG. 3, only the staircase ascending manner of the mobile robot is considered. The staircase ascending manner of the mobile robot may be further divided into a quasi-static staircase ascending manner and a static staircase ascending manner. The staircase ascending action sequence shown in FIG. 4 is a quasi-static staircase ascending action sequence, and the staircase ascending action sequence shown in FIG. 5 is a static staircase ascending action sequence.

The quasi-static staircase ascending refers to that at each moment in a staircase ascending process, a center of gravity of the entire mobile robot is in a ground support area, or the center of gravity of the entire mobile robot deviates from a support area to a sufficiently small extent. In this case, an overall posture of the robot at each moment can be maintained in a balanced state, or can be restored to a balanced state at any time by a particular method.

Static staircase ascending refers to that at each moment in a staircase ascending process, a center of gravity of the entire mobile robot is in a ground support area, and an overall posture of the robot at each moment in a static state can be maintained in a balanced state without any other condition.

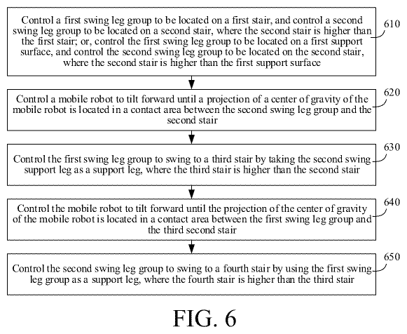

Quasi-static staircase ascending: Based on some embodiments shown in FIG. 3, FIG. 6 shows a flowchart of a quasi-static staircase ascending method for a mobile robot. An example in which the method is performed by a controller for a mobile robot shown in FIG. 1 or FIG. 2 is configured for description. The controller of the mobile robot is located in a body or outside the mobile robot. The method shown in FIG. 6 includes the following operations.

Operation 610: Control a first swing leg group to be located on a first stair, and control a second swing leg group to be located on a second stair, where the second stair is higher than the first stair; or, control the first swing leg group to be located on a first support surface, and control the second swing leg group to be located on the second stair, where the second stair is higher than the first support surface.

In a quasi-static staircase ascending process shown in FIG. 6, the first stair and the second stair are adjacent stairs, and the second swing leg group is not in contact with a side wall of a third stair when being located on the second stair. That is, in a quasi-static staircase ascending process, the second swing leg is not supported by the third stair, the second swing leg group does not receive a support force from the third stair, and the second swing leg group only receives a support force from the second stair.

With reference to FIG. 4, part (A) in FIG. 4 shows that the first swing leg group 10 is located on the first stair F1, the second swing leg group 20 is located on the second stair F2, and the second stair F2 is higher than the first stair F1. In this case, the second swing leg group 20 is not in contact with the third stair F3.

Operation 620: Control a mobile robot to tilt forward until a projection of a center of gravity of the mobile robot is located in a contact area between the second swing leg group and the second stair.

With reference to FIG. 4, after the mobile robot tilts forward, part (B) in FIG. 4 shows that the first swing leg group 10 is located on the first stair F1, the second swing leg group 20 is located on the second stair F2, and the projection of the center of gravity of the mobile robot is located in a contact area between the second swing leg group 20 and the second stair F2.

In FIG. 4, an unfilled circle is configured for representing the center of gravity of each part of the mobile robot, and a black-filled circle is configured for representing an overall center of gravity of the mobile robot. In FIG. 4, unfilled circles are configured for separately representing centers of gravity of an upper body, a thigh, and a calf of the mobile robot. The overall center of gravity of the mobile robot may be represented by using the following formula:

$$c = \frac{\sum {m}_{i} {c}_{i}}{\sum {m}_{i}}$$

where c is the overall center of gravity of the mobile robot, and mi is a mass of each part of the mobile robot, and cᵢ is a center of gravity of each part of the mobile robot, and i is a positive integer. Part (B) in FIG. 4 shows that in this case, the projection of the center of gravity of the mobile robot is located in the contact area between the second swing leg group 20 and the second stair F2.

In some embodiments, the second swing leg group includes a plurality of second swing legs, the second swing leg includes a second leg assembly and a second wheel, each second wheel is in point contact with the second stair, and the plurality of second wheels are in line contact with the second stair. Therefore, the contact area between the second swing leg group and the second stair is a contact line.

In some embodiments, in a process of controlling the mobile robot to tilt forward, the projection of the center of gravity of the mobile robot needs to be always kept falling within a geometric figure surrounded by a contact point between the second swing leg group and the second stair and a contact point between the first swing leg group and the first stair. Since the geometric figure has a large range, additional control does not need to be performed as long as ensuring that a forward tilting speed of the mobile robot is relatively low. However, when the projection of the center of gravity of the mobile robot changes, that is, there is an acceleration when the mobile robot starts to tilt forward. In this case, the mobile robot may be unstable. Therefore, a control method still needs to be set to ensure stability of the mobile robot. For details, refer to related descriptions of a first control method below.

Operation 630: Control the first swing leg group to swing to a third stair by taking the second swing support leg as a support leg, where the third stair is higher than the second stair.

In a quasi-static staircase ascending process shown in FIG. 6, the second stair and the third stair are adjacent stairs. With reference to FIG. 4, parts (C), (D), and (E) in FIG. 4 show a process of controlling first swing leg group 10 to swing to the third stair F3 by using the second swing leg group 20 as a support leg.

After the first swing leg group leaves the first stair, the center of gravity of the mobile robot needs to be controlled to be always kept in a contact area between the second swing leg group and the second stair. The second swing leg group includes a plurality of second swing legs, the second swing leg includes a second leg assembly and a second wheel, there is point contact between each second wheel and the second stair, and the plurality of second wheel are in line contact with the second stair. Therefore, the contact area between the second swing leg group and the second stair is a contact line.

In some embodiments, in a process of controlling the first swing leg group to swing to the third stair, the mobile robot is controlled to tilt forward until the first swing leg group is parallel to a gravity direction, and then the mobile robot is controlled to tilt backward until the first swing leg group swings to the third stair. With reference to FIG. 4, part (C) in FIG. 4 shows that the mobile robot is in a forward tilt state. Part (E) in FIG. 4 shows that the mobile robot is in a backward tilt state. For details, refer to the related descriptions of a second control method below.

Operation 640: Control the mobile robot to tilt forward until the projection of the center of gravity of the mobile robot is located in a contact area between the first swing leg group and the third second stair.

The foregoing operation 620 and operation 630 describe related operations of swinging the first swing leg group by using the second swing leg group as a support leg in the staircase ascending action process. Operation 640 and operation 650 are similarly implemented as related operations of swinging the second swing leg group by using the first swing leg group as a support leg in the staircase ascending action process.

FIG. 4 only shows a half cycle of a staircase ascending action. Similarly, a similar lower half cycle may be obtained. In a second half cycle, the second swing leg group is swung. For operation 640, refer to the description of operation 620.

In some embodiments, the first swing leg group includes a plurality of first swing legs, the first swing leg includes a first leg assembly and a first wheel, each first wheel is in point contact with the third stair, and the plurality of first wheels are in line contact with the third stair. Therefore, a contact area between the first swing leg group and the third stair is a contact line.

In some embodiments, in a process of controlling the mobile robot to tilt forward, a projection of a center of gravity of the mobile robot needs to be always kept falling within a geometric figure surrounded by a contact point between the second swing leg group and the second stair and a contact point between the first swing leg group and the third stair. Since the geometric figure has a large range, additional control does not need to be performed as long as ensuring that a forward tilting speed of the mobile robot is relatively low. However, when the projection of the center of gravity of the mobile robot changes, that is, there is an acceleration when the mobile robot starts to tilt forward. In this case, the mobile robot may be unstable. Therefore, a control method still needs to be set to ensure stability of the mobile robot. For details, refer to related descriptions of a first control method below.

Operation 650: Control the second swing leg group to swing to a fourth stair by using the first swing leg group as a support leg, where the fourth stair is higher than the third stair.

In a quasi-static staircase ascending process shown in FIG. 6, the third stair and the fourth stair are adjacent stairs.

After the second swing leg group leaves the second stair, the center of gravity of the mobile robot needs to be controlled to be always kept in the contact area between the first swing leg group and the third stair. The first swing leg group includes a plurality of first swing legs, the first swing leg includes a first leg assembly and a first wheel, each first wheel is in point contact with the third stair, and the plurality of first wheels are in line contact with the third stair. Therefore, the contact area between the second swing leg group and the second stair is a contact line.

In some embodiments, in a process of controlling the second swing leg group to swing to the fourth stair, the mobile robot is controlled to tilt forward until the second swing leg group is parallel to a gravity direction, and then the mobile robot is controlled to tilt backward until the second swing leg group swings to the fourth stair. For details, refer to the related descriptions of a second control method below.

Similarly, operation 650 may similarly refer to the descriptions of operation 630.

In conclusion, the foregoing solution provides a quasi-static staircase ascending solution. Before a swing leg ascends a staircase, the projection of the center of gravity of a robot is first moved to a contact area between the support leg and the stair, and a solution of migrating the center of gravity of the robot is provided, so that the robot can continuously and stably ascend the staircase.

Based on some embodiments shown in FIG. 6, the quasi-static staircase ascending process further includes at least one of the following two control methods. A first control method is configured for ensuring stability in a process of migrating a center of gravity of a mobile robot when both a first swing leg group and a second swing leg group of the mobile robot are in contact with a stair. A second control method is configured for controlling the mobile robot to tilt forward when only one swing leg group of the mobile robot is in contact with the stair.

According to the first control method, an end of the first swing leg of the first swing leg group includes a first wheel, and an end of the second swing leg of the second swing leg group includes a second wheel. Based on some embodiments shown in FIG. 6, operation 620 may be replaced with the following operations. The mobile robot is configured to tilt forward, and at least one first wheel of the first swing leg group and at least one second wheel of the second swing leg group are driven to control a horizontal position and a vertical height of the mobile robot to remain unchanged until the projection of the center of gravity of the mobile robot is located in the contact area between the second swing leg group and the second stair.

In some embodiments, the at least one first wheel of the first swing leg group is controlled to control the first swing leg group not to move horizontally and the second swing leg group not to move vertically until a stair contact force of the first swing leg group is less than a stair contact force of the second swing leg group. The at least one second wheel of the second swing leg group is driven to control the second swing leg group not to move horizontally and the first swing leg group not to move vertically until the projection of the center of gravity of the mobile robot is located in the contact area between the second swing leg group and the second stair. The stair contact force refers to a support force received from a stair.

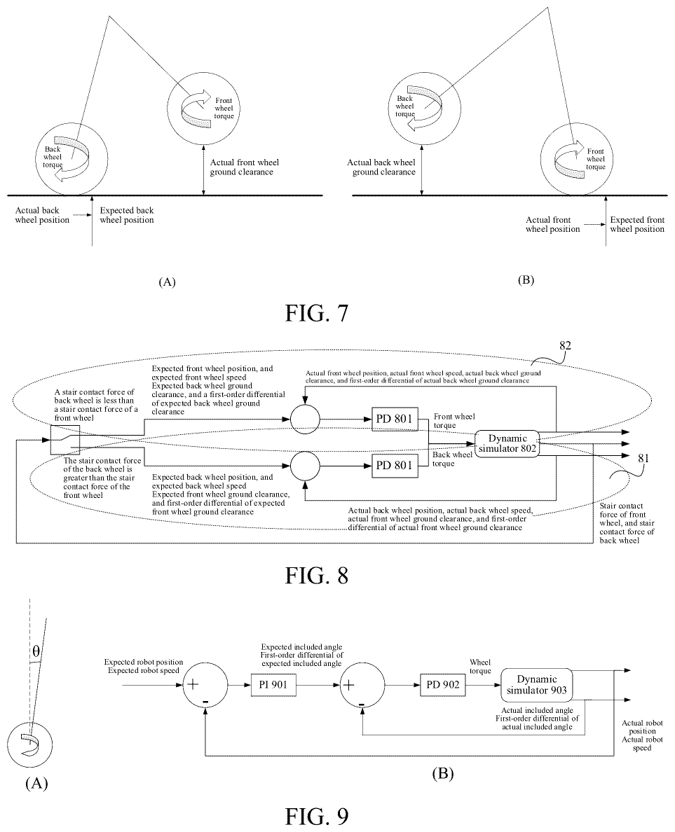

Schematically, with reference to FIG. 7, part (A) in FIG. 7 shows a case in which the stair contact force of the first swing leg group is greater than the stair contact force of the second swing leg group, that is, a case in which the stair contact force of at least one first wheel is greater than the stair contact force of at least one second wheel. In this case, the first wheel is a back wheel (back), and the second wheel is a front wheel (front). That is, part (A) in FIG. 7 shows a case in which a stair contact force of the back wheel is greater than a stair contact force of the front wheel, and is represented as f_{contact,b}>f_{contact,f}.

FIG. 8 shows a first control branch 81. The first control branch 81 is a case in which the stair contact force of the back wheel is greater than the stair contact force of the front wheel. Under the first control branch 81, a deviation between an actual value and an expected value of each control amount is calculated according to an expected back wheel position x_{b,ref}, an expected back wheel speed \dot{x}_{b,ref}, an expected front wheel ground clearance z_{f,ref}, a first-order differential ż_{f,ref} of the expected front wheel ground clearance, an actual back wheel position x_{b}, an actual back wheel speed \dot{x}_{b}, an actual front wheel ground clearance z_{f}, and a first-order differential \dot{f}_{f} of the expected front wheel ground clearance, and the deviation is sent to a PD controller 801. The PD controller 801 calculates a back wheel torque, and sends the back wheel torque to a dynamic simulator 802. The dynamic simulator 802 drives a back wheel of the mobile robot.

Schematically, with reference to FIG. 7, part (B) in FIG. 7 shows a case in which the stair contact force of the first swing leg group is less than the stair contact force of the second swing leg group, that is, a case in which the stair contact force of the at least one first wheel is less than the stair contact force of the at least one second wheel. In this case, the first wheel is a back wheel (back), and the second wheel is a front wheel (front). That is, part (B) in FIG. 7 shows a case in which the stair contact force of the back wheel is less than the stair contact force of the front wheel, and is represented as f_{contact,b}<f_{contact,f}.

FIG. 8 shows a first control branch 82. The first control branch 82 is a case in which the stair contact force of the back wheel is greater than the stair contact force of the front wheel. Under the first control branch 82, a deviation between an actual value and an expected value of each control amount is calculated according to an expected front wheel position x_{f,ref}, an expected front wheel speed \dot{x}_{f,ref}, an expected back wheel ground clearance z_{b,ref}, a first-order differential ż_{b,ref} of the expected back wheel ground clearance, an actual front wheel position x_{f}, an actual front wheel speed \dot{x}_{f}, an actual back wheel ground clearance z_{b}, and a first-order differential ż_{b} of the expected back wheel ground clearance, and the deviation is sent to a PD controller 801. The PD controller 801 calculates a front wheel torque, and sends the front wheel torque to a dynamic simulator 802. The dynamic simulator 802 drives a front wheel of the mobile robot.

Based on some embodiments shown in FIG. 6, operation 640 may be replaced with the following operations. The mobile robot is controlled to tilt forward, and at least one second wheel of the second swing leg group and at least one first wheel of the first swing leg group are driven to control a horizontal position and a vertical height of the mobile robot not to change until the projection of the center of gravity of the mobile robot is located on the contact range between the first swing leg group and the third stair.

In some embodiments, the at least one second wheel of the second swing leg group is driven to control the second swing leg group not to move horizontally and the first swing leg group not to move vertically until a stair contact force of the second swing leg group is less than a stair contact force of the first swing leg group; and the at least one first wheel of the first swing leg group is driven to control the first swing leg group not to move horizontally and the second swing leg group not to move vertically until the projection of the center of gravity of the mobile robot is located in the contact area between the first swing leg group and the third stair. The stair contact force refers to a support force received from a stair.

Schematically, with reference to FIG. 7, part (A) in FIG. 7 shows a case in which the stair contact force of the second swing leg group is greater than the stair contact force of the first swing leg group, that is, a case in which the stair contact force of the at least one first wheel is greater than the stair contact force of the at least one second wheel. In this case, the second wheel is a back wheel (back), and the first wheel is a front wheel (front). That is, part (A) in FIG. 7 shows a case in which the stair contact force of the back wheel is greater than the stair contact force of the front wheel, and is represented as f_{contact,b}>f_{contact,f}.

FIG. 8 shows a first control branch 81. The first control branch 81 is a case in which the stair contact force of the back wheel is greater than the stair contact force of the front wheel. Under the first control branch 81, a deviation between an actual value and an expected value of each control amount is calculated according to an expected back wheel position x_{b,ref}, an expected back wheel speed \dot{x}_{b,ref}, an expected front wheel ground clearance z_{f,ref}, a first-order differential ż_{f,ref} of the expected front wheel ground clearance, an actual back wheel position x_{b}, an actual back wheel speed \dot{x}_{b}, an actual front wheel ground clearance z_{f}, and a first-order differential ż_{f} of the expected front wheel ground clearance, and the deviation is sent to a PD controller 801. The PD controller 801 calculates a back wheel torque, and sends the back wheel torque to a dynamic simulator 802. The dynamic simulator 802 drives a back wheel of the mobile robot.

Schematically, with reference to FIG. 7, part (B) in FIG. 7 shows a case in which the stair contact force of the second swing leg group is greater than the stair contact force of the first swing leg group (that is, a case in which the stair contact force of the at least one second wheel is less than the stair contact force of the at least one first wheel). In this case, the second wheel is a back wheel (back), and the first wheel is a front wheel (front). That is, part (B) in FIG. 7 shows a case in which the stair contact force of the back wheel is less than the stair contact force of the front wheel, and is represented as f_{contact,b}<f_{contact,f}.

FIG. 8 shows a first control branch 82. The first control branch 82 is a case in which the stair contact force of the back wheel is greater than the stair contact force of the front wheel. Under the first control branch 82, a deviation between an actual value and an expected value of each control amount is calculated according to an expected front wheel position x_{f,ref}, an expected front wheel speed \dot{x}_{f,ref}, an expected back wheel ground clearance z_{b,ref}, a first-order differential ż_{b,ref} of the expected back wheel ground clearance, an actual front wheel position x_{f}, an actual front wheel speed \dot{x}_{f}, an actual back wheel ground clearance z_{b}, and a first-order differential ż_{b} of the expected back wheel ground clearance, and the deviation is sent to a PD controller 801. The PD controller 801 calculates a front wheel torque, and sends the front wheel torque to a dynamic simulator 802. The dynamic simulator 802 drives a front wheel of the mobile robot.

In conclusion, before the swing leg ascends a staircase, the projection of the center of gravity of the robot needs to be projected and moved to a contact area between the support legs and the stair. The foregoing solution provides a control method, so that the robot can be maintained stable in a process of migrating the center of gravity. In addition, the foregoing method is applicable to a robot with a wheel at a leg end, the wheel is in point contact with the stair surface, and a plurality of wheels are in line contact with the stair surface. The foregoing provides a solution in which a robot that is in line contact with the stair can be maintained stable in the process of migrating the center of gravity.

According to a second control method, based on some embodiments shown in FIG. 6, operation 630 further includes: controlling, in a process of controlling the first swing leg group to swing to the third stair, the mobile robot to tilt forward until the first swing leg group is parallel to a gravity direction, and controlling the mobile robot to tilt backward until the first swing leg group swings to the third stair.

In some embodiments, an end of the first swing leg of the first swing leg group includes a first wheel, and an end of the second swing leg of the second swing leg group includes a second wheel. Operation 630 is an operation of controlling the first swing leg group to swing to a third stair by using the second swing leg group as a support leg. In a process of controlling the first swing leg group to swing to the third stair, the at least one second wheel of the second swing leg group is driven to control the mobile robot to tilt forward until the first swing leg group is parallel to a gravity direction, and to control the mobile robot to tilt backward until the first swing leg group swings to the third stair.

With reference to FIG. 9, part (A) in FIG. 9 shows control amounts of a second wheel in a process of swinging the first swing leg group: an included angle θ (a tilt angle of the mobile robot), a first-order differential (not shown) of the included angle θ, a robot position (not shown), and a robot speed (not shown). In a process of swinging the first swing leg group, the included angle θ is detected, and the included angle θ is used as the control amount to control the second wheel to be driven.

Part (B) in FIG. 9 shows a method for controlling an included angle θ. An expected robot position x_{robot,ref}, an expected robot speed \dot{x}_{robot,ref}, an actual robot position x_{robot}, and an actual robot speed \dot{x}_{robot} are obtained. Deviations between actual values and expected values of the two control amounts are calculated, and the deviations are sent to a PI controller 901. The PI controller 901 calculates an expected angle θ_{ref} and a first-order differential of an expected angle \dot{θ}_{ref}. Deviations between actual values and expected values of the included angle θ and the first-order differential \dot{θ} of the included angle are calculated. The deviations are sent to a PD controller 902. The PD controller 902 calculates a torque τ of the second wheel, and sends the torque τ to a dynamic simulator 903. The dynamic simulator 903 drives the second wheel of the mobile robot.

Based on some embodiments shown in FIG. 6, operation 650 further includes: controlling, in a process of controlling the second swing leg group to swing to the fourth stair, the mobile robot to tilt forward until the second swing leg group is parallel to a gravity direction, and controlling the mobile robot to tilt backward until the first swing leg group swings to the fourth stair.

In some embodiments, an end of the first swing leg includes a first wheel, and an end of the second swing leg includes a second wheel. Operation 650 is an operation of controlling the second swing leg group to swing to a fourth stair by using the first swing leg group as a support leg. In a process of controlling the second swing leg group to swing to the fourth stair, the at least one first wheel of the first swing leg group is driven to control the mobile robot to tilt forward until the second swing leg group is parallel to a gravity direction, and to control the mobile robot to tilt backward until the second swing leg group swings to the fourth stair.

With reference to FIG. 9, part (A) in FIG. 9 shows control amounts of a first wheel in a process of swinging the second swing leg group: an included angle θ (a tilt angle of the mobile robot), a first-order differential (not shown) of the included angle θ, a robot position (not shown), and a robot speed (not shown). In a process of swinging the second swing leg group, the included angle θ is detected, and the included angle θ is used as the control amount to control the first wheel to be driven.

Part (B) in FIG. 9 shows a method for controlling an included angle θ. An expected robot position x_{robot,ref}, an expected robot speed x_{robot,ref}, an actual robot position x_{robot}, and an actual robot speed \dot{r}_{robot} are obtained. Deviations between actual values and expected values of the two control amounts are calculated, and the deviations are sent to a PI controller 901. The PI controller 901 calculates an expected angle θ_{ref} and a first-order differential of an expected angle θref. Deviations between actual values and expected values of the included angle θ and the first-order differential θ of the included angle are calculated. The deviations are sent to a PD controller 902. The PD controller calculates a torque τ of the first wheel, and sends the torque τ to a dynamic simulator 903. The dynamic simulator 903 drives the first wheel of the mobile robot.

In conclusion, the foregoing method provides a robot control method. In a process of controlling a swing leg of a robot to ascend a staircase, a tilt angle of a mobile robot is detected and controlled, so that the robot can be maintained stable in the process of ascending the staircase. The foregoing method is applicable to a robot with a wheel at a leg end, the wheel is in point contact with a stair surface, and a plurality of wheels are in line contact with the stair surface. The foregoing provides a method for quasi-static staircase ascending of a robot that is in line contact with the stair.

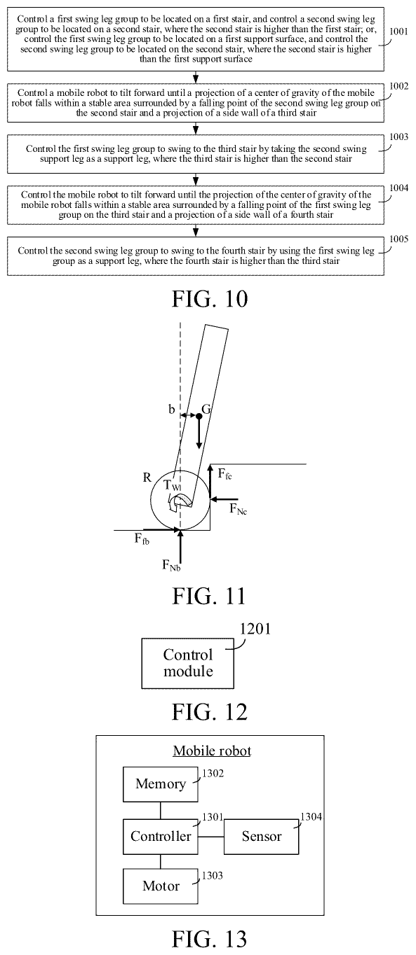

Static staircase ascending, FIG. 10 shows a flowchart of a static staircase ascending method for a mobile robot. An example in which the method is performed by a controller for a mobile robot shown in FIG. 1 or FIG. 2 is configured for description. The controller of the mobile robot is located in a body or outside the mobile robot. The method shown in FIG. 10 includes the following operations.

Operation 1001: Control a first swing leg group to be located on a first stair, and control a second swing leg group to be located on a second stair, where the second stair is higher than the first stair; or, control the first swing leg group to be located on a first support surface, and control the second swing leg group to be located on the second stair, where the second stair is higher than the first support surface.

In a static staircase ascending process shown in FIG. 10, the first stair and the second stair are adjacent stairs, the second stair and the third stair are adjacent stairs, and the third stair and the fourth stair are adjacent stairs. The second swing leg group is in contact with a side wall of the third stair when being located on the second stair. That is, in a static staircase ascending process, the second swing leg is supported by the second stair and the third stair simultaneously. The second swing leg group simultaneously receives a support force from the second stair and the third stair.

With reference to FIG. 5, part (A) in FIG. 5 shows that the first swing leg group 10 is located on the first stair F1, the second swing leg group 20 is located on the second stair F2, and the second stair F2 is higher than the first stair F1. In this case, the second swing leg group 20 is in contact with a side wall of the third stair F3.

Operation 1002: Control the mobile robot to tilt forward until a projection of a center of gravity of the mobile robot falls within a stable area surrounded by a falling point of the second swing leg group on the second stair and a projection of a side wall of a third stair.

With reference to FIG. 5, after the mobile robot tilts forward, part (B) in FIG. 5 shows that the first swing leg group 10 is located on a first stair F1, the second swing leg group 20 is located on a second stair F2, and the projection of the center of gravity of the mobile robot is located slightly in front of a contact area between the second swing leg group 20 and the second stair F2. The projection of the center of gravity of the mobile robot falls within a stable area formed by the second swing leg group 20 and the side wall of the third stair F3. The stable area refers to an area surrounded by the falling point of the second swing leg group and the projection of the side wall of the third stair. The second swing leg includes a second leg assembly and a second wheel, and the stable area includes an area surrounded by projections of centers of circles of the plurality of second wheel and the side wall of the third stair.

In FIG. 5, an unfilled circle is configured for representing the center of gravity of each part of the mobile robot, and a black-filled circle is configured for representing an overall center of gravity of the mobile robot. In FIG. 5, unfilled circles are configured for separately representing centers of gravity of an upper body, a thigh, and a calf of the mobile robot. The overall center of gravity of the mobile robot may be represented by using the following formula:

$$c = \frac{\sum {m}_{i} {c}_{i}}{\sum {m}_{i}}$$

where c is the overall center of gravity of the mobile robot, and mᵢ is a mass of each part of the mobile robot, and cᵢ is a center of gravity of each part of the mobile robot, and i is a positive integer. Part (B) in FIG. 5 shows that in this case, the projection of the center of gravity of the mobile robot is located slightly in front of a contact area between the second swing leg group 20 and the second stair F2.

In some embodiments, the second swing leg group includes a plurality of second swing legs, the second swing leg includes a second leg assembly and a second wheel, each second wheel is in point contact with the second stair, and the plurality of second wheels are in line contact with the second stair. Therefore, the contact area between the second swing leg group and the second stair is a contact line.

Operation 1003: Control the first swing leg group to swing to the third stair by taking the second swing support leg as a support leg, where the third stair is higher than the second stair.

With reference to FIG. 5, parts (C), (D), and (E) of FIG. 4 show a process of controlling first swing leg group 10 to swing to the third stair F3 by using the second swing leg group 20 as a support leg.

Because the mobile robot does not tilt by only remaining the center of gravity in the stable area, an additional control algorithm is not needed. This is a biggest difference between static staircase ascending and the foregoing quasi-static staircase ascending.

Operation 1004: Control the mobile robot to tilt forward until the projection of the center of gravity of the mobile robot falls within a stable area surrounded by a falling point of the first swing leg group on the third stair and a projection of a side wall of a fourth stair.

The foregoing operation 1002 and operation 1003 describe related operations of swinging the first swing leg group by using the second swing leg group as a support leg in the staircase ascending action process. Operation 1004 and operation 1005 are similarly implemented as related operations of swinging the second swing leg group by using the first swing leg group as a support leg in the staircase ascending action process.

FIG. 5 only shows a half cycle of a staircase ascending action. Similarly, a similar lower half cycle may be obtained. In a second half cycle, the second swing leg group is swung. For operation 1004, refer to the description of operation 1002.

The projection of the center of gravity of the mobile robot falls within a stable area formed by the first swing leg group and the side wall of the fourth stair. The stable area refers to an area surrounded by a falling point of the first swing leg group and a projection of the side wall of the fourth stair. The first swing leg includes a first leg assembly and a first wheel, and the stable area includes an area surrounded by the projections of the centers of circles of the plurality of first wheels and the side wall of the fourth stair.

In some embodiments, the first swing leg group includes a plurality of first swing legs, the first swing leg includes a first leg assembly and a first wheel, each first wheel is in point contact with the third stair, and the plurality of first wheels are in line contact with the third stair. Therefore, a contact area between the first swing leg group and the third stair is a contact line.

Operation 1005: Control the second swing leg group to swing to the fourth stair by using the first swing leg group as a support leg, where the fourth stair is higher than the third stair.

The second swing leg group is controlled to swing to the fourth stair by using the first swing leg group as a support leg. Because the mobile robot does not tilt by only remaining the center of gravity in the stable range, an additional control algorithm is not needed. This is a biggest difference between static staircase ascending and the foregoing quasi-static staircase ascending.

In conclusion, the foregoing solution provides a static staircase ascending solution. Before a swing leg ascends a staircase, the projection of the center of gravity of a robot is first moved to a stable area formed by the support leg and a side wall of a higher stair, and a solution of migrating the center of gravity of the robot is provided, so that the robot can continuously and stably ascend the staircase.

Moreover, the foregoing method is applicable to a robot with a wheel at a leg end, the wheel is in point contact with a stair surface, and a plurality of wheels are in line contact with the stair surface. The foregoing provides a method for static staircase ascending of a robot that is in line contact with the stair. In a static staircase ascending process, a tilt angle of the robot does not need to be detected, and opposite moment of a wheel motor does not need to be given, as long as a projection of a center of gravity falls within a stable area formed by the wheel and the side wall of the stair.

Based on some embodiments shown in FIG. 10, operation 1003 further includes: controlling, in a process of controlling the first swing leg group to swing to the third stair, the second swing leg group to be always supported by the third stair by using a target that the force on the mobile robot satisfies a first stability condition.

In some embodiments, an end of the second swing leg of the second swing leg group includes a second wheel, the second wheel has a second radius, and the second swing leg group is supported by the third stair by using at least one second wheel. The first stability condition includes:

(1) a sum of a second support force and a first friction force is zero; the second support force is a support force from the side wall of the third stair, and the first friction force is a friction force from the stair surface of the second stair; a direction of the second support force is opposite to a direction of the first friction force; (2) a sum of a first support force, a second friction force, and gravity of the mobile robot is zero; the first support force is a support force from the stair surface of the second stair, and the second friction force is a friction force from the side wall of the third stair; a direction of the first support force and a direction of the second friction force are the same, a ratio of the second friction force to the second support force is less than or equal to a coefficient of friction, and a ratio of the first friction force to the first support force is less than or equal to a coefficient of friction; (3) a product of the second support force and the second radius is equal to a sum of a product of the second friction force and the second radius and a product of the gravity of the mobile robot and a forward tilt distance; the forward tilt distance is a horizontal distance between a center of gravity of the mobile robot and a center of a circle of the second wheel; (4) a product of the first support force and the second radius is equal to a sum of a product of the first friction force and the second radius and a product of the gravity of the mobile robot and a remaining distance; and a sum of the remaining distance and the forward tilt distance is the second radius.

The first stability condition is a stability condition that needs to be satisfied when the mobile robot swings the second swing leg group. FIG. 11 shows a schematic diagram of a force analysis of a mobile robot. In FIG. 11, T_{w} is a torque of a second wheel, F_{Nb} is a first support force. F_{Nb} is from a stair surface of a second stair. F_{Nc} is a second support force, and F_{Nc} is from a side wall of a third stair. F_{fb} is a first friction force, and F_{fb} is from the stair surface of the second stair. F_{fc} is a second friction force, and F_{fc} is from the side wall of the third stair. G is gravity of the mobile robot, R is a radius of the second wheel, b is a forward tilt distance of the mobile robot, and b is a horizontal distance between a center of gravity of the mobile robot and a center of a circle of the second wheel. μis a coefficient of friction of the stair. The foregoing first stability condition is expressed by using an equation as:

$$\begin{matrix}\begin{matrix}{F}_{N c} + {F}_{f b} = 0 ; & {F}_{N b} \geq 0 ; & \vert \frac{{F}_{f c}}{{F}_{N c}} \vert \leq μ ;\end{matrix} \\ \begin{matrix}{F}_{N b} + {F}_{f c} + G = 0 ; & {F}_{N c} \leq 0 ; & \vert \frac{{F}_{f b}}{{F}_{N b}} \vert \leq μ ;\end{matrix} \\ {F}_{N c} R - {F}_{f c} R - G b = 0 ; \\ {F}_{N b} R - {F}_{f b} R - G ( b - R ) = 0 ;\end{matrix}$$

Schematically, when the radius of the second wheel is R=82.5 mm, and the coefficient of friction μ=0.5, a balance condition is b=0 mm to 49.5 mm. When the radius of the second wheel is R=82.5 mm, and μ=0.8, b=0 mm to 72.5 mm. Therefore, an effective stability range of the center of gravity of the mobile robot is less than the radius R of the wheel, and is affected by the coefficient of friction.

Based on some embodiments shown in FIG. 10, operation 1005 further includes: controlling, in a process of controlling the second swing leg group to swing to the fourth stair, the first swing leg group to be always supported by the fourth stair by using a target that the force on the mobile robot satisfies a second stability condition.

In some embodiments, an end of the first swing leg of the first swing leg group includes first wheel, the first wheel has a first radius, the first swing leg group is supported by the third stair by using at least one first wheel. The second stability condition includes:

(1) a sum of a fourth support force and a third friction force is zero; the fourth support force is a support force from the side wall of the fourth stair, and the third friction force is a friction force from a stair surface of the second stair; a direction of the fourth support force is opposite to a direction of the third friction force; (2) a sum of a third support force, a fourth friction force, and gravity of the mobile robot is zero; the third support force is a support force from the stair surface of the second stair, and the fourth friction force is a friction force from the side wall of the fourth stair; a direction of the third support force and a direction of the fourth friction force are the same, a ratio of the fourth friction force to the fourth support force is less than or equal to a coefficient of friction, and a ratio of the third friction force to the third support force is less than or equal to a coefficient of friction; (3) a product of the fourth support force and the first radius is equal to a sum of a product of the fourth friction force and the first radius and a product of the gravity of the mobile robot and a forward tilt distance; the forward tilt distance is a horizontal distance between a center of gravity of the mobile robot and a center of a circle of the first wheel; (4) a product of the third support force and the first radius is equal to a sum of a product of the third friction force and the first radius and a product of the gravity of the mobile robot and a remaining distance; and a sum of the remaining distance and the forward tilt distance is the first radius.

The second stability condition is a stability condition that needs to be satisfied when the mobile robot swings the first swing leg group. FIG. 11 shows a schematic diagram of a force analysis of a mobile robot. In FIG. 11, T_{w} is a torque of a first wheel, F_{Nb} is a third support force, and F_{Nb} is from a stair surface of a third stair. F_{Nc} is a fourth support force, and F_{Nc} is from a side wall of a fourth stair. F_{fb} is a third friction force, and F_{fb} is from a stair surface of the third stair. F_{fc} is a fourth friction force, and F_{fc} is from the side wall of the fourth stair. G is gravity of the mobile robot, R is a radius of the first wheel, b is a forward tilt distance of the mobile robot, and b is a horizontal distance between a center of gravity of the mobile robot and a center of a circle of the first wheel. μ is a coefficient of friction of the stair. The foregoing second stability condition is expressed by using an equation as:

$$\begin{matrix}\begin{matrix}{F}_{N c} + {F}_{f b} = 0 ; & {F}_{N b} \geq 0 ; & \vert \frac{{F}_{f c}}{{F}_{N c}} \vert \leq μ ;\end{matrix} \\ \begin{matrix}{F}_{N b} + {F}_{f c} + G = 0 ; & {F}_{N c} \leq 0 ; & \vert \frac{{F}_{f b}}{{F}_{N b}} \vert \leq μ ;\end{matrix} \\ {F}_{N c} R - {F}_{f c} R - G b = 0 ; \\ {F}_{N b} R - {F}_{f b} R - G ( b - R ) = 0 ;\end{matrix}$$

Schematically, when the radius of the first wheel is R=82.5 mm, and the coefficient of friction μ=0.5, a balance condition is b=0 mm to 49.5 mm. When the radius of the first wheel is R=82.5 mm, and μ=0.8, b=0 mm to 72.5 mm. Therefore, an effective stability range of the center of gravity of the mobile robot is less than the radius R of the wheel, and is affected by the coefficient of friction.

In conclusion, the foregoing method provides a stability condition in a static staircase ascending process of the mobile robot. In this case, compared with quasi-static staircase ascending, a tilt angle of the robot does not need to be detected, opposite moment of a wheel motor does not need to be provided, and stability feedback control does not need to be performed.

FIG. 12 shows an apparatus for controlling a mobile robot according to some embodiments. The mobile robot includes a first swing leg group and a second swing leg group. At least one of the first swing leg group and the second swing leg group includes a plurality of swing legs, the first swing leg group and the second swing leg group are distributed side by side, and a rotation shaft of the first swing leg group and a rotation shaft of the second swing leg group are located in the same vertical plane. The apparatus includes:
a control module 1201, configured to control the first swing leg group to be located on a first stair or a first support surface, and control the second swing leg group to be located on a second stair.

The control module 1201 is further configured to control the first swing leg group to swing to a third stair by using the second swing leg group as a support leg.

The control module 1201 is further configured to control the second swing leg group to swing to a fourth stair by using the first swing leg group as a support leg.

In some embodiments, the control module 1201 is further configured to control the first swing leg group to telescope and swing to the third stair by using the second swing leg group as the support leg, and control the second swing leg group to telescope and swing to the fourth stair by using the first swing leg group as the support leg.

In some embodiments, the control module 1201 is further configured to control the first swing leg group to shorten and swing by using the second swing leg group as a support leg until an extension direction of the first swing leg group is parallel to a gravity direction, and control the first swing leg group to extend and swing until the first swing leg group is located on the third stair.

The control module 1201 is further configured to control the second swing leg group to shorten and swing by using the first swing leg group as the support leg until an extension direction of the second swing leg group is parallel to a gravity direction, and control the second swing leg group to extend and swing until the second swing leg group is located on the fourth stair.

In some embodiments, the second stair is higher than the first stair when the first swing leg group is located on the first stair; the second stair is higher than the first support surface when the first swing leg group is located on the first support surface; the second stair and the third stair are adjacent stairs, and the third stair is higher than the second stair; the second swing leg group is not in contact with a side wall of the third stair when being located on the second stair; the third stair and the fourth stair are adjacent stairs, and the fourth stair is higher than the third stair; and the first swing leg group is not in contact with a side wall of the fourth stair when being located on the third stair.

In some embodiments, the control module 1201 is further configured to control the mobile robot to tilt forward until a projection of a center of gravity of the mobile robot is located in a contact area between the second swing leg group and the second stair.

The control module 1201 is further configured to control the mobile robot to tilt forward until a projection of a center of gravity of the mobile robot is located in the contact area between the first swing leg group and the third stair.

In some embodiments, an end of the first swing leg of the first swing leg group includes a first wheel, and an end of the second swing leg of the second swing leg group includes a second wheel. The control module 1201 is further configured to control the mobile robot to tilt forward, and drive at least one first wheel of the first swing leg group and at least one second wheel of the second swing leg group to control a horizontal position and a vertical height of the mobile robot to remain unchanged until a projection of a center of gravity of the mobile robot is located in the contact area between the second swing leg group and the second stair.

The control module 1201 is further configured to control the mobile robot to tilt forward, and drive the at least one second wheel of the second swing leg group and the at least one first wheel of the first swing leg group, to control a horizontal position and a vertical height of the mobile robot to remain unchanged until a projection of a center of gravity of the mobile robot is located on a contact range between the first swing leg group and the third stair.

In some embodiments, the control module 1201 is further configured to drive the at least one first wheel of the first swing leg group to control the first swing leg group not to move horizontally and the second swing leg group not to move vertically until a stair contact force of the first swing leg group is less than a stair contact force of the second swing leg group. The at least one second wheel of the second swing leg group is driven to control the second swing leg group not to move horizontally and the first swing leg group not to move vertically until the projection of the center of gravity of the mobile robot is located in the contact area between the second swing leg group and the second stair.

The control module 1201 is further configured to drive the at least one second wheel of the second swing leg group to control the second swing leg group not to move horizontally and the first swing leg group not to move vertically until a stair contact force of the second swing leg group is less than a stair contact force of the first swing leg group. The at least one first wheel of the first swing leg group is driven to control the first swing leg group not to move horizontally and the second swing leg group not to move vertically until the projection of the center of gravity of the mobile robot is located in the contact area between the first swing leg group and the third stair.

In some embodiments, the control module 1201 is further configured to control, in a process of controlling the first swing leg group to swing to the third stair, the mobile robot to tilt forward until the first swing leg group is parallel to a gravity direction, and control the mobile robot to tilt backward until the first swing leg group swings to the third stair.

The control module 1201 is further configured to control, in a process of controlling the second swing leg group to swing to the fourth stair, the mobile robot to tilt forward until the second swing leg group is parallel to a gravity direction, and control the mobile robot to tilt backward until the second swing leg group swings to the fourth stair.

In some embodiments, an end of the first swing leg of the first swing leg group includes a first wheel, and an end of the second swing leg of the second swing leg group includes a second wheel. The control module 1201 is further configured to: drive, in a process of controlling the first swing leg group to swing to the third stair, the at least one second wheel of the second swing leg group to control the mobile robot to tilt forward until the first swing leg group is parallel to a gravity direction, and to control the mobile robot to tilt backward until the first swing leg group swings to the third stair.

The control module 1201 is further configured to: drive, in a process of controlling the second swing leg group to swing to the fourth stair, the at least one first wheel of the first swing leg group to control the mobile robot to tilt forward until the second swing leg group is parallel to a gravity direction, and to control the mobile robot to tilt backward until the second swing leg group swings to the fourth stair.

In some embodiments, the second stair is higher than the first stair when the first swing leg group is located on the first stair; the second stair is higher than the first support surface when the first swing leg group is located on the first support surface; the second stair and the third stair are adjacent stairs, and the third stair is higher than the second stair; the second swing leg group is in contact with a side wall of the third stair when being located on the second stair; the third stair and the fourth stair are adjacent stairs, and the fourth stair is higher than the third stair; and the first swing leg group is not in contact with a side wall of the fourth stair when being located on the third stair.

In some embodiments, the control module 1201 is further configured to control the mobile robot to tilt forward until the projection of the center of gravity of the mobile robot falls within a stable area surrounded by a falling point of the second swing leg group on the second stair and a projection of the side wall of the third stair. The control module 1201 is further configured to control the mobile robot to tilt forward until the projection of the center of gravity of the mobile robot falls within a stable area surrounded by the falling point of the first swing leg group on the third stair and a projection of the side wall of the fourth stair.

In some embodiments, the control module 1201 is further configured to control, in a process of controlling the first swing leg group to swing to the third stair, the second swing leg group to be always supported by the third stair by using a target that a force on the mobile robot satisfies a first stability condition.

The control module 1201 is further configured to control, in a process of controlling the second swing leg group to swing to the fourth stair, the first swing leg group to be always supported by the fourth stair by using a target that a force on the mobile robot satisfies a second stability condition.

In some embodiments, an end of the second swing leg of the second swing leg group includes a second wheel, the second wheel has a second radius, and the second swing leg group is supported on a third stair by using at least one second wheel. The first stability condition includes: a sum of a second support force and a first friction force is zero; the second support force is a support force from the side wall of the third stair, and the first friction force is a friction force from the stair surface of the second stair; a direction of the second support force is opposite to a direction of the first friction force; a sum of a first support force, a second friction force, and gravity of the mobile robot is zero; the first support force is a support force from the stair surface of the second stair, and the second friction force is a friction force from the side wall of the third stair; a direction of the first support force and a direction of the second friction force are the same, a ratio of the second friction force to the second support force is less than or equal to a coefficient of friction, and a ratio of the first friction force to the first support force is less than or equal to a coefficient of friction; a product of the second support force and the second radius is equal to a sum of a product of the second friction force and the second radius and a product of the gravity of the mobile robot and a forward tilt distance; the forward tilt distance is a horizontal distance between a center of gravity of the mobile robot and a center of a circle of the second wheel; a product of the first support force and the second radius is equal to a sum of a product of the first friction force and the second radius and a product of the gravity of the mobile robot and a remaining distance; and a sum of the remaining distance and the forward tilt distance is the second radius.

In some embodiments, an end of the first swing leg of the first swing leg group includes a first wheel, the first wheel has a first radius, and the first swing leg group is supported by the fourth stair by using at least one first wheel. The second stability condition includes: a sum of a fourth support force and a third friction force is zero; the fourth support force is a support force from the side wall of the fourth stair, and the third friction force is a friction force from a stair surface of the second stair; a direction of the fourth support force is opposite to a direction of the third friction force; a sum of a third support force, a fourth friction force, and gravity of the mobile robot is zero; the third support force is a support force from the stair surface of the second stair, and the fourth friction force is a friction force from the side wall of the fourth stair; a direction of the third support force and a direction of the fourth friction force are the same, a ratio of the fourth friction force to the fourth support force is less than or equal to a coefficient of friction, and a ratio of the third friction force to the third support force is less than or equal to a coefficient of friction; a product of the fourth support force and the first radius is equal to a sum of a product of the fourth friction force and the first radius and a product of the gravity of the mobile robot and a forward tilt distance; the forward tilt distance is a horizontal distance between a center of gravity of the mobile robot and a center of a circle of the first wheel; a product of the third support force and the first radius is equal to a sum of a product of the third friction force and the first radius and a product of the gravity of the mobile robot and a remaining distance; and a sum of the remaining distance and the forward tilt distance is the first radius.

In conclusion, two swing leg groups (at least one of the two swing leg groups includes a plurality of swing legs) ascend/descend a staircase alternatively, and a solution for a mobile robot to ascend/descend a staircase is provided. In this solution, safety of the mobile robot is relatively high, difficulty in implementing ascending/descending a staircase is relatively low, the robot has a relatively large stability margin, and a real machine implementation risk can be reduced.

FIG. 13 shows a structural block diagram of a mobile robot according to some embodiments. The mobile robot includes a controller 1301 and a memory 1302.

The controller 1301 may include one or more processing cores, for example, a 4-core processor or an 8-core processor. The controller 1301 may be implemented in at least one hardware form of a digital signal processor (DSP), a field-programmable gate array (FPGA), and a programmable logic array (PLA). The controller 1301 may alternatively include a main processor and a coprocessor. The main processor is a processor configured to process data in an awake state, and is alternatively referred to as a central processing unit (CPU). The coprocessor is a low power consumption processor configured to process the data in a standby state. In some embodiments, the controller 1301 may be integrated with a graphics processing unit (GPU). The GPU is configured to render and draw content that needs to be displayed on a display screen. In some embodiments, the controller 1301 may further include an artificial intelligence (AI) processor. The AI processor is configured to process computing operations related to machine learning.

The memory 1302 may include one or more computer-readable storage media. The computer-readable storage medium may be non-transient. The memory 1302 may further include a high-speed random access memory and a nonvolatile memory, for example, one or more disk storage devices or flash storage devices. In some embodiments, the non-transitory computer-readable storage medium in the memory 1302 is configured to store at least one instruction, and the at least one instruction is configured to be executed by the controller 1301 to implement the method for controlling a mobile robot according to some embodiments.

In some embodiments, the mobile robot 1300 may optionally include: at least one motor 1303 and at least one sensor 1304. The at least one motor 1303 is configured to receive a control instruction sent by the controller 1301, and drive the mobile robot to perform actions. The at least one motor 1303 drives each joint of the mobile robot to perform actions such as rotating/telescoping/fixing. The at least one sensor 1304 is configured to obtain state information of the mobile robot, where the state information includes an internal state of the mobile robot and/or an external state (environment information) of the mobile robot. The at least one sensor 1304 sends the state information of the mobile robot to the controller 1301 to control the mobile robot to perform related actions.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for controlling a mobile robot, performed by a controller of the mobile robot, and the method comprising:
controlling a first swing leg group to be located on a first stair or a first support surface, and controlling a second swing leg group to be located on a second stair;
controlling the first swing leg group to swing to a third stair with the second swing leg group as a support leg; and
controlling the second swing leg group to swing to a fourth stair with the first swing leg group as a support leg;
wherein the first swing leg group and the second swing leg group comprise rotation shafts and a plurality of swing legs,
wherein the first swing leg group and the second swing leg group are distributed side by side, and
wherein the rotation shaft of the first swing leg group and the rotation shaft of the second swing leg group are located in the same vertical plane.

2. The method according to claim 1, further comprising:
controlling the first swing leg group to telescope and swing to the third stair with the second swing leg group as the support leg; and
controlling the second swing leg group to telescope and swing to a fourth stair with the first swing leg group as the support leg.

3. The method according to claim 1, further comprising:
controlling the first swing leg group to retract and swing with the second swing leg group as the support leg such that an extension direction of the first swing leg group is parallel to a gravity direction;
controlling the first swing leg group to extend and swing such that the first swing leg group is located on the third stair;
controlling the second swing leg group to retract and swing with the first swing leg group as the support leg such that an extension direction of the second swing leg group is parallel to the gravity direction; and
controlling the second swing leg group to extend and swing such that the second swing leg group is located on the fourth stair.

4. The method according to claim 1,
wherein the second stair is higher than the first stair and the first support surface, the second stair and the third stair are adjacent stairs, the third stair is higher than the second stair,
wherein the second swing leg group is not in contact with a side wall of the third stair when the second swing leg group is located on the second stair, the third stair and the fourth stair are adjacent stairs, the fourth stair is higher than the third stair, and
wherein the first swing leg group is not in contact with a side wall of the fourth stair when the first swing leg group is located on the third stair.

5. The method according to claim 1, further comprising:
controlling the mobile robot to tilt forward such that a projection of a center of gravity of the mobile robot is located in a contact area between the second swing leg group and the second stair before the first swing leg group swings to the third stair; and
controlling the mobile robot to tilt forward such that the projection of the center of gravity of the mobile robot is located in a contact area between the first swing leg group and the third stair before the second swing leg group swings to the fourth stair.

6. The method according to claim 5, wherein an end of the first swing leg in the first swing leg group comprises at least one first wheel, and an end of the second swing leg in the second swing leg group comprises at least one second wheel, the method further comprising:
controlling the mobile robot to tilt forward;
driving the at least one first wheel of the first swing leg group and the at least one second wheel of the second swing leg group;
controlling a horizontal position and a vertical height of the mobile robot remain unchanged such that the projection of the center of gravity of the mobile robot is located in the contact area between the second swing leg group and the second stair;
controlling the mobile robot to tilt forward;
driving the at least one second wheel of the second swing leg group and the at least one first wheel of the first swing leg group;
controlling a horizontal position and a vertical height of the mobile robot remain unchanged such that the projection of the center of gravity of the mobile robot is located on the contact range between the first swing leg group and the third stair.

7. The method according to claim 6, further comprising:
driving the at least one first wheel of the first swing leg group, and controlling the first swing leg group not to move horizontally and the second swing leg group not to move vertically such that a stair contact force of the first swing leg group is less than a stair contact force of the second swing leg group;
driving the at least one second wheel of the second swing leg group, and controlling the second swing leg group not to move horizontally and the first swing leg group not to move vertically such that a projection of a center of gravity of the mobile robot is located in the contact area between the second swing leg group and the second stair;
driving the at least one second wheel of the second swing leg group, and controlling the second swing leg group not to move horizontally and the first swing leg group not to move vertically such that a stair contact force of the second swing leg group is less than a stair contact force of the first swing leg group; and
driving the at least one first wheel of the first swing leg group, and controlling the first swing leg group not to move horizontally and the second swing leg group not to move vertically such that the projection of the center of gravity of the mobile robot is located in the contact area between the first swing leg group and the third stair.

8. The method according to claim 4, further comprising:
controlling, based on the first swing leg group swinging to the third stair, the mobile robot to tilt forward such that the first swing leg group is parallel to a gravity direction;
controlling the mobile robot to tilt backward such that the first swing leg group swings to the third stair;
controlling, based on the second swing leg group swinging to the fourth stair, the mobile robot to tilt forward such that the second swing leg group is parallel to a gravity direction; and
controlling the mobile robot to tilt backward such that the second swing leg group swings to the fourth stair.

9. The method according to claim 8,
wherein an end of the first swing leg in the first swing leg group comprises at least one first wheel, and an end of the second swing leg in the second swing leg group comprises at least one second wheel, the method further comprising:
driving, based on the first swing leg group swinging to the third stair, at least one second wheel of the second swing leg group;
controlling the mobile robot to tilt forward such that the first swing leg group is parallel to a gravity direction;
controlling the mobile robot to tilt backward such that the first swing leg group swings to the third stair;
driving, based on the second swing leg group swinging to the fourth stair, at least one first wheel of the first swing leg group;
controlling the mobile robot to tilt forward such that the second swing leg group is parallel to a gravity direction; and
controlling the mobile robot to tilt backward such that the second swing leg group swings to the fourth stair.

10. The method according to claim 1,
wherein the second stair is higher than the first stair and the first support surface, the second stair and the third stair are adjacent stairs, the third stair is higher than the second stair,
wherein the second swing leg group is in contact with a side wall of the third stair when the second swing leg group is located on the second stair, and
wherein the third stair and the fourth stair are adjacent stairs, the fourth stair is higher than the third stair, and the first swing leg group is in contact with a side wall of the fourth stair when the first swing leg group is located on the third stair.

11. The method according to claim 10, further comprising:
controlling the mobile robot to tilt forward such that a projection of a center of gravity of the mobile robot falls within a stable area surrounded by a falling point of the second swing leg group on the second stair and a projection of a side wall of the third stair; and
controlling, before the second swing leg group swings to the fourth stair, the mobile robot to tilt forward such that the projection of the center of gravity of the mobile robot falls within the stable area surrounded by a falling point of the first swing leg group on the third stair and a projection of a side wall of the fourth stair.

12. The method according to claim 10, further comprising:
controlling, based on the first swing leg group swinging to the third stair, the second swing leg group to remain supported by the third stair such that a force on the mobile robot satisfies a first stability condition; and
controlling, based on the second swing leg group swinging to the fourth stair, the first swing leg group to remain supported by the fourth stair such that the force on the mobile robot satisfies a second stability condition.

13. The method according to claim 12,
wherein an end of a second swing leg in the second swing leg group comprises at least one second wheel, the second wheel has a second radius, and the second swing leg group is supported by the third stair based on using the at least one second wheel,
wherein the first stability condition comprises a first support force, a second support force, a first friction force, and a second friction force, and
wherein the first support force is a support force from the stair surface of the second stair, the second support force is a support force from the side wall of the third stair, the first friction force is a friction force from a stair surface of the second stair, and the second friction force is a friction force from the side wall of the third stair,
wherein a sum of the second support force and the first friction force is zero, and a sum of the first support force, the second friction force, and gravity of the mobile robot is zero,
wherein a direction of the second support force is opposite to a direction of the first friction force, a direction of the first support force and a direction of the second friction force are the same,
wherein a ratio of the second friction force to the second support force is less than or equal to a coefficient of friction, and a ratio of the first friction force to the first support force is less than or equal to a coefficient of friction,
wherein a product of the second support force and the second radius is equal to a sum of a product of the second friction force and the second radius, and a product of the gravity of the mobile robot and a forward tilt distance,
wherein the forward tilt distance is a horizontal distance between a center of gravity of the mobile robot and a center of a circle of the second wheel, and
wherein a product of the first support force and the second radius is equal to a sum of a product of the first friction force and the second radius, and a product of the gravity of the mobile robot and a remaining distance, and
wherein a sum of the remaining distance and the forward tilt distance is the second radius.

14. The method according to claim 12,
wherein an end of a first swing leg in the first swing leg group comprises at least one first wheel, the at least one first wheel has a first radius, and the first swing leg group is supported by the fourth stair based on using the at least one first wheel,
wherein the second stability condition comprises a third support force, a fourth support force, a third friction force, and a fourth friction force,
wherein the third support force is a support force from the stair surface of the second stair, the fourth support force is a support force from the side wall of the fourth stair, the third friction force is a friction force from a stair surface of the second stair, and the fourth friction force is a friction force from the side wall of the fourth stair,
wherein a sum of the fourth support force and the third friction force is zero, and a sum of the third support force, the fourth friction force, and gravity of the mobile robot is zero,
wherein a direction of the fourth support force is opposite to a direction of the third friction force,
wherein a direction of the third support force and a direction of the fourth friction force are the same, a ratio of the fourth friction force to the fourth support force is less than or equal to a coefficient of friction, and a ratio of the third friction force to the third support force is less than or equal to a coefficient of friction,
wherein a product of the fourth support force and the first radius is equal to a sum of a product of the fourth friction force and the first radius, and a product of the gravity of the mobile robot and the forward tilt distance,
wherein the forward tilt distance is a horizontal distance between a center of gravity of the mobile robot and a center of a circle of the first wheel,
wherein a product of the third support force and the first radius is equal to a sum of a product of the third friction force and the first radius, and a product of the gravity of the mobile robot and a remaining distance, and
wherein a sum of the remaining distance and the forward tilt distance is the first radius.

15. An apparatus for controlling a mobile robot, comprising:
at least one memory configured to store program code; and
at least one processor configured to read the program code and operate as instructed by the program code, the program code comprising:
control code configured to cause at least one of the at least one processor to control the first swing leg group to be located on a first stair or a first support surface, and control the second swing leg group to be located on a second stair;
wherein the control code is further configured to cause at least one of the at least one processor to control the first swing leg group to swing to a third stair with the second swing leg group as a support leg,
wherein the control code is further configured to cause at least one of the at least one processor to control the second swing leg group to swing to a fourth stair with the first swing leg group as a support leg,
wherein the first swing leg group and the second swing leg group comprise rotation shafts and a plurality of swing legs,
wherein the first swing leg group and the second swing leg group are distributed side by side, and
wherein the rotation shaft of the first swing leg group and the rotation shaft of the second swing leg group are located in the same vertical plane.

16. The apparatus according to claim 15, wherein the control code is further configured to cause at least one of the at least one processor to:
control the first swing leg group to telescope and swing to the third stair with the second swing leg group as the support leg; and
control the second swing leg group to telescope and swing to the fourth stair with the first swing leg group as the support leg.

17. The apparatus according to claim 15, wherein the control code is further configured to cause at least one of the at least one processor to:
control the first swing leg group to retract and swing with the second swing leg group as the support leg such that an extension direction of the first swing leg group is parallel to a gravity direction;
control the first swing leg group to extend and swing such that the first swing leg group is located on the third stair;
control the second swing leg group to retract and swing with the first swing leg group as the support leg such that an extension direction of the second swing leg group is parallel to the gravity direction; and
control the second swing leg group to extend and swing such that the second swing leg group is located on the fourth stair.

18. The apparatus according to claim 15,
wherein the second stair is higher than the first stair and the first support surface, the second stair and the third stair are adjacent stairs, the third stair is higher than the second stair,
wherein the second swing leg group is not in contact with a side wall of the third stair when the second swing leg group is located on the second stair, the third stair and the fourth stair are adjacent stairs, the fourth stair is higher than the third stair, and
wherein the first swing leg group is not in contact with a side wall of the fourth stair when the first swing leg group is located on the third stair.

19. The apparatus according to claim 15, wherein the control code is further configured to cause at least one of the at least one processor to:
control the mobile robot to tilt forward such that a projection of a center of gravity of the mobile robot is located in a contact area between the second swing leg group and the second stair before the first swing leg group swings to the third stair; and
control the mobile robot to tilt forward such that the projection of the center of gravity of the mobile robot is located in a contact area between the first swing leg group and the third stair before the second swing leg group swings to the fourth stair.

20. A non-transitory computer-readable storage medium, storing computer code which, when executed by at least one processor, causes the at least one processor to at least:
control a first swing leg group to be located on a first stair or a first support surface, and control a second swing leg group to be located on a second stair;
control the first swing leg group to swing to a third stair with the second swing leg group as a support leg; and
control the second swing leg group to swing to a fourth stair with the first swing leg group as a support leg;
wherein the first swing leg group and the second swing leg group comprise rotation shafts and a plurality of swing legs,
wherein the first swing leg group and the second swing leg group are distributed side by side, and
wherein the rotation shaft of the first swing leg group and the rotation shaft of the second swing leg group are located in the same vertical plane.
